(19) United States
(12) Patent Application Publication
(10) Pub. No.: US 2005/0075975 A1
(43) Pub. Date: Apr. 7, 2005

(54) Allocating funds for payment of transactional account statements

(76) Inventors: Warren M. Rosner, South Jordan, UT (US); David W. Neddo, Midvale, UT (US); Steven B. Smith, Holladay, UT (US); Dennis L. Higbee, Riverton, UT (US)

Correspondence Address: Michael F. Krieger;KIRTON & McCONKIE, Suite 1800, 60 East South Temple, Salt Lake City, UT, 84111, US

(21) Appl. No.: 10/677,608

(22) Filed: Oct. 2, 2003

(51) Int. Cl. G06F 17/60

(52) U.S. Cl. 705/40

(57) ABSTRACT

Systems and methods for providing electronic management of transactional accounts. A computer device is used to provide financial resource allocation and accountability among various groups of accounts, including source accounts and transactional accounts. When a user employs a transactional account to make a purchase, the amount of the purchase is electronically set aside, frozen or otherwise held from a source account and preserved until a payment is required for the transactional account at the close of a billing period. Accordingly, when a payment for the transactional account is required, funds are available for full payment of all purchases made during the billing cycle, thereby affording financial discipline to the user.

### RELATED APPLICATIONS

This application claims priority to U.S. patent application Ser. No. 09/870,142, filed May 30, 2001 and entitled METHOD AND SYSTEM FOR MANAGING SPENDING THROUGH ACCOUNT ALLOCATION, which claims priority to U.S. patent application Ser. No. 09/829,364, filed Apr. 9, 2001 and entitled METHODS AND SYSTEMS FOR JOB-BASED ACCOUNTING, which claims priority to both U.S. Provisional Application Ser. No. 60/226,187, filed Aug. 18, 2000 and entitled METHODS AND SYSTEMS FOR JOB-BASED ACCOUNTING, and to U.S. Provisional Application No. 60/198,961, filed Apr. 21, 2000 and entitled METHOD AND SYSTEM FOR MANAGING SPENDING THROUGH ACCOUNT ALLOCATION, all of which are incorporated herein by reference.

### BACKGROUND OF THE INVENTION

1. Field of the Invention

The present invention relates to systems and methods for providing electronic management of transactional accounts. In particular, the present invention relates to systems and methods for allocating funds for payment of one or more transactional account statements.

2. Background and Related Art

The development of the personal computer and of financial accounting programs has simplified personal and business accounting. The financial accounting programs that are currently available provide users with simple yet robust accounting means for tracking financial resources. The programs typically provide an accounting for managing a checking account, a savings account, and money market funds, and may provide an ability to perform on-line banking services with their respective financial institution.

Users can currently utilize bill paying options and account recordation of transactions performed by the bank without having to receive an end-of-month financial statement from the financial institution. Also, users are able to keep up-to-date records of financial transactions, which can include checks that have been written, credit card bills that have been paid, deposits that have been made to retirement accounts, or automatic bill payment options.

The financial accounting programs provide rudimentary budgeting systems that enable users to determine where their money is invested or spent. The users are able to establish their own budget and the resources used to cover the budget are typically drawn from a single revenue source. At an end of a financial period (e.g., a week, month, quarter, year, etc.) a statement is provided that indicates how the revenue was allocated from the revenue source.

While the financial accounting programs currently available allow users to establish a budget, the budgetary discipline is not felt until a reconciliation of funds distributed during a given financial period is performed that reports an accurate accounting of payments and distributions. Only then do users know whether they have been disciplined enough to follow the established budget.

When financial discipline does not occur, users amass consumer debt having high interest rates. The consumer debt can become insurmountable. As a result, individuals heavy laden with consumer debt are filing for bankruptcy in record numbers.

Thus, while financial accounting programs are currently available, the accounting programs fail to achieve financial discipline for users. Accordingly, it would be an improvement in the art to augment or even replace current financial techniques with other techniques.

### SUMMARY OF THE INVENTION

The present invention relates to systems and methods for providing electronic management of transactional accounts. In particular, the present invention relates to systems and methods for allocating funds for payment of one or more transactional account statements.

Implementation of the present invention takes place in association with a computer device that is used to provide financial resource allocation and accountability among various groups of accounts, including source accounts and transactional accounts. A source account includes funds or assets that are readily available to the user. Examples of source accounts include savings accounts, checking accounts, money market accounts, investment accounts, etc. A transactional account is based on credit or equity and may be used to purchase a product or service, but requires that the amount accrued on the transactional account be paid at a later time. Examples of transactional accounts include credit card accounts, home equity accounts, etc.

In one implementation, when a user employs a transactional account to make a purchase, the amount of the purchase is electronically set aside from a source account and preserved until a payment is required of the transactional account at the close of a billing period. Thus, for example, the user selects a credit card to use to purchase a product. The corresponding credit card company authorizes the purchase, includes the purchase amount on the user's credit card account, and eventually bills the user for all amounts on the credit card account at the end of a billing period. At the time the credit card is used to perform the purchase, the purchase amount is set aside from a source account (e.g., a checking account) having sufficient funds until the credit card statement is received. When a payment is required for the credit card account, the purchase amount that was set aside from the savings account is used to pay the credit card statement.

Therefore, in accordance with one implementation of the present invention, a source account is essentially debited each time a transactional account is used to perform a transaction and the amount debited is preserved until payment of the transactional account is required. Accordingly, when a payment of the billing cycle is required, funds are available for full payment of all purchases made during the billing cycle, thereby affording financial discipline to the user.

While the methods and processes of the present invention have proven to be particularly useful in the area of providing financial discipline to users of credit card accounts, those skilled in the art can appreciate that the methods and processes can be used in a variety of different applications to provide financial accounting and discipline to users of all types of transactional and source accounts.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

In order that the manner in which the above recited and other features and advantages of the present invention are obtained, a more particular description of the invention will be rendered by reference to specific embodiments thereof, which are illustrated in the appended drawings. Understanding that the drawings depict only typical embodiments of the present invention and are not, therefore, to be considered as limiting the scope of the invention, the present invention will be described and explained with additional specificity and detail through the use of the accompanying drawings in which:

FIG. 1 illustrates a representative system that provides a suitable operating environment for use of the present invention;

FIG. 2 illustrates a representative networked system in accordance with an embodiment of the present invention;

FIG. 3 illustrates a block diagram of a plurality of accounts established by a given user in accordance with the present invention;

FIG. 4 illustrates a block diagram of a given account selected from FIG. 3 detailing financial information organized in accordance with the present invention;

FIG. 5 illustrates an information window view on a computer device of money envelopes in accordance with the present invention;

FIG. 6 illustrates an information window of a money envelope of FIG. 5 selected in accordance with the present invention;

FIG. 7 illustrates an information window of transaction details of a transaction selected in the money envelope window of FIG. 6 in accordance with the present invention;

FIG. 8 depicts account information as selected in the account folder of FIG. 5;

FIG. 9 is an illustration of an account information detail window as selected from FIG. 8;

FIG. 10 illustrates an upkeep information window as selected in FIG. 5 in accordance with the present invention; and

FIG. 11 is a flow chart that provides a representative method for allocating funds for payment of a transactional account statement.

### DETAILED DESCRIPTION OF THE INVENTION

The present invention relates to systems and methods for providing electronic management of transactional accounts. In particular, the present invention relates to systems and methods for allocating funds for payment of one or more transactional account statements.

Embodiments of the present invention takes place in association with a computer device that is used to provide financial resource allocation and accountability among various groups of accounts, including source accounts and transactional accounts. In the disclosure and in the claims the term “source account” shall refer to an account that includes funds or assets that are readily available to the user. Examples of such source accounts include savings accounts, checking accounts, money market accounts, investment accounts, etc. In the disclosure and in the claims the term “transactional account” shall refer to an account that is based on credit or equity and may be used to purchase a product or service, but requires that the amount accrued on the transactional account be paid at a later time. Examples of such transactional accounts include credit card accounts, home equity accounts, etc.

In one embodiment, when a user employs a transactional account to make a purchase, the amount of the purchase is electronically set aside from a source account and preserved until a payment is required of the transactional account at the close of a billing period. In this manner, when a payment of the transactional account is required, funds are available for full payment, thereby affording financial discipline to the user.

The following disclosure of the present invention is grouped into three subheadings, namely “Exemplary Operating Environment,” “Managing Spending through Account Allocation” and “Allocating Funds for a Transactional Account Statement.” The utilization of the subheadings is for convenience of the reader only and is not to be construed as limiting in any sense.

### Exemplary Operating Environment

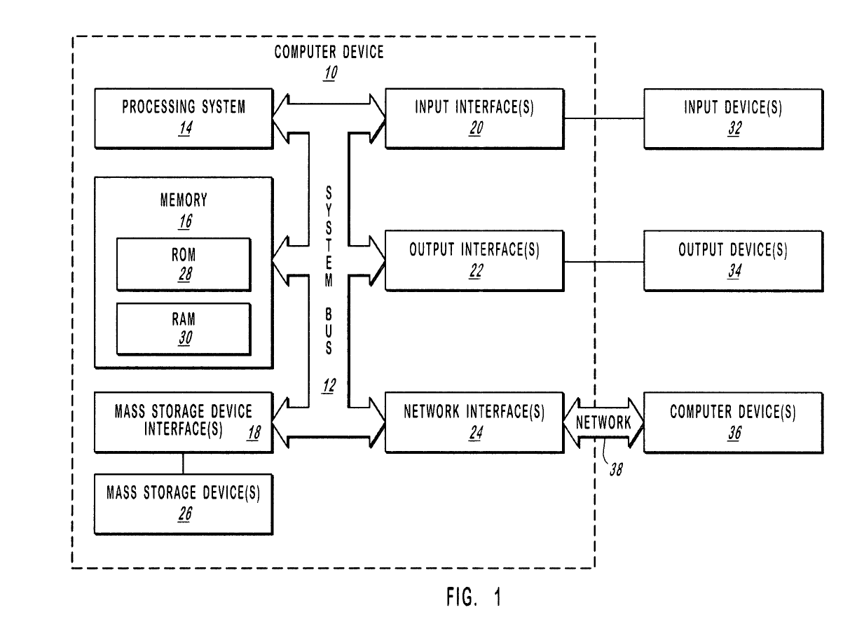

Since embodiments of the present invention take place in association with a computer device that is used to provide financial resource allocation and accountability among various groups of accounts, including source accounts and transactional accounts, FIG. 1 and the corresponding discussion are intended to provide a general description of a suitable operating environment in which the invention may be implemented. One skilled in the art will appreciate that the invention may be practiced by one or more computing devices and in a variety of system configurations, including in a networked configuration.

Embodiments of the present invention embrace one or more computer readable media, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system.

With reference to FIG. 1, a representative system for implementing the invention includes computer device 10, which may be a general-purpose or special-purpose computer. For example, computer device 10 may be a personal computer, a notebook computer, a personal digital assistant (“PDA”) or other hand-held device, a workstation, a minicomputer, a mainframe, a supercomputer, a multi-processor system, a network computer, a processor-based consumer electronic device, or the like.

Computer device 10 includes system bus 12, which may be configured to connect various components thereof and enables data to be exchanged between two or more components. System bus 12 may include one of a variety of bus structures including a memory bus or memory controller, a peripheral bus, or a local bus that uses any of a variety of bus architectures. Typical components connected by system bus 12 include processing system 14 and memory 16. Other components may include one or more mass storage device interfaces 18, input interfaces 20, output interfaces 22, and/or network interfaces 24, each of which will be discussed below.

Processing system 14 includes one or more processors, such as a central processor and optionally one or more other processors designed to perform a particular function or task. It is typically processing system 14 that executes the instructions provided on computer readable media, such as on memory 16, a magnetic hard disk, a removable magnetic disk, a magnetic cassette, an optical disk, or from a communication connection, which may also be viewed as a computer readable medium.

Memory 16 includes one or more computer readable media that may be configured to include or includes thereon data or instructions for manipulating data, and may be accessed by processing system 14 through system bus 12. Memory 16 may include, for example, ROM 28, used to permanently store information, and/or RAM 30, used to temporarily store information. ROM 28 may include a basic input/output system (“BIOS”) having one or more routines that are used to establish communication, such as during start-up of computer device 10. RAM 30 may include one or more program modules, such as one or more operating systems, application programs, and/or program data.

One or more mass storage device interfaces 18 may be used to connect one or more mass storage devices 26 to system bus 12. The mass storage devices 26 may be incorporated into or may be peripheral to computer device 10 and allow computer device 10 to retain large amounts of data. Optionally, one or more of the mass storage devices 26 may be removable from computer device 10. Examples of mass storage devices include hard disk drives, magnetic disk drives, tape drives and optical disk drives. A mass storage device 26 may read from and/or write to a magnetic hard disk, a removable magnetic disk, a magnetic cassette, an optical disk, or another computer readable medium. Mass storage devices 26 and their corresponding computer readable media provide nonvolatile storage of data and/or executable instructions that may include one or more program modules such as an operating system, one or more application programs, other program modules, or program data. Such executable instructions are examples of program code means for implementing steps for methods disclosed herein.

One or more input interfaces 20 may be employed to enable a user to enter data and/or instructions to computer device 10 through one or more corresponding input devices 32. Examples of such input devices include a keyboard and alternate input devices, such as a mouse, trackball, light pen, stylus, or other pointing device, a microphone, a joystick, a game pad, a satellite dish, a scanner, a camcorder, a digital camera, and the like. Similarly, examples of input interfaces 20 that may be used to connect the input devices 32 to the system bus 12 include a serial port, a parallel port, a game port, a universal serial bus (“USB”), a firewire (IEEE 1394), or another interface.

One or more output interfaces 22 may be employed to connect one or more corresponding output devices 34 to system bus 12. Examples of output devices include a monitor or display screen, a speaker, a printer, and the like. A particular output device 34 may be integrated with or peripheral to computer device 10. Examples of output interfaces include a video adapter, an audio adapter, a parallel port, and the like.

One or more network interfaces 24 enable computer device 10 to exchange information with one or more other local or remote computer devices, illustrated as computer devices 36, via a network 38 that may include hardwired and/or wireless links. Examples of network interfaces include a network adapter for connection to a local area network (“LAN”) or a modem, wireless link, or other adapter for connection to a wide area network (“WAN”), such as the Internet. The network interface 24 may be incorporated with or peripheral to computer device 10. In a networked system, accessible program modules or portions thereof may be stored in a remote memory storage device. Furthermore, in a networked system computer device 10 may participate in a distributed computing environment, where functions or tasks are performed by a plurality of networked computer devices.

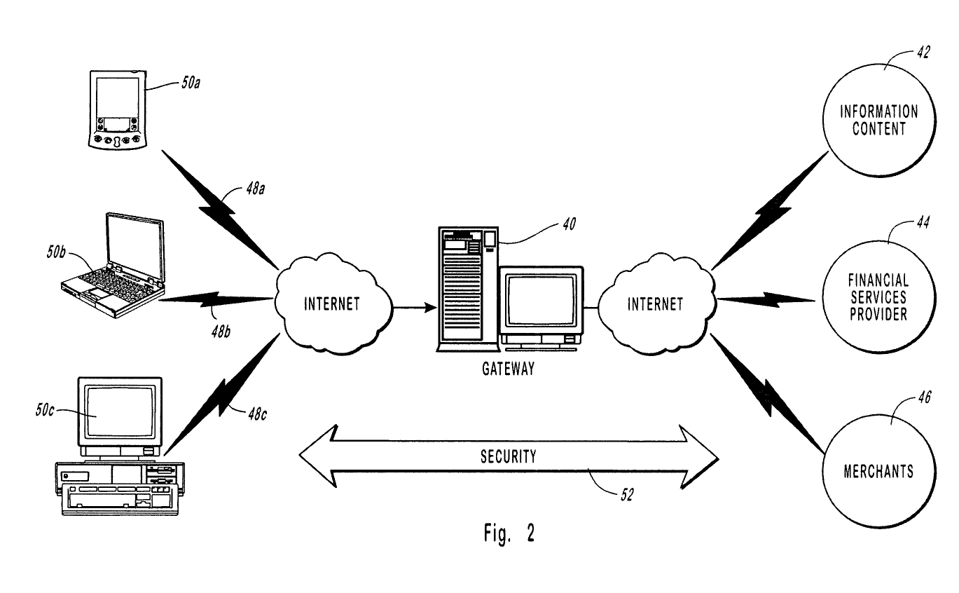

While those skilled in the art will appreciate that the invention may be practiced in networked computing environments with many types of computer system configurations, FIG. 2 represents a representative embodiment of the present invention in a networked environment to allocate funds for payment of transactional account statements. In FIG. 2, a secure Internet infrastructure is illustrated that includes a provider gateway 40, which is a robust computer system typically used for managing web interaction and Internet access and communication in a commercial setting. Gateway 40 provides two-way communication between a user and further content destinations such as information content source 42, financial service provider 44, and/or on-line merchants or off-line merchants via bill paying, illustrated as merchants 46.

The user at a computer device 50 connects to gateway 40 via wireless means 48a, a direct connection wireline 48b, or a cable modem or other cable-type connections 48c. Security means 52 is provided so that the transactions provided by either the user on one side of the gateway or to the content providers on the other side of the gateway are secure at all times. At any time, the user can be offline and perform any transaction required or desired and then synchronize the transaction(s) when on-line so that it will be executed and performed.

In one embodiment, the system is designed to operate in a graphical user interface mode where the user manipulates data and information via such pointing devices as a mouse or roller ball, with keyboard entry also being provided, among others. As such, in one embodiment the system is designed to be operated within a Windows-type, MAC, JAVA, HTML, EPOC, etc., operating environment that is readily implemented by those skilled in the art. Browsing devises use JAVA or HTML. Others use resident Operating Systems.

Embodiments of the present invention operate in a computer environment, which environment includes a computer device. Data is synchronized to a secure central data storage site on a network, such as the Internet, where the data is accessed, previous transactions viewed, and where transactions are made or allocated by any wire or wireless device with multiple simultaneous connections to the same centralized data. Moreover, embodiments embrace providing users with an ability to interact with on-line financial institutions, such as banks, investment groups, credit organizations, etc., with either direct hands-on interaction or in an automated fashion defined by the user.

### Managing Spending through Account Allocation

As provided above, embodiments of the present invention take place in association with a computer device that is used to provide financial resource allocation and accountability among various groups of accounts, including source accounts and transactional accounts. The following provides a discussion relating to the management of spending through account allocation in accordance with embodiments of the present invention.

Embodiments embrace the creation of an environment where a user spends from traditional expense accounts as though they were individual spending or bank accounts. When a user receives funds, such as cash, the user allocates those funds into one or more source accounts. The user also allocates an amount that is budgeted for spending in a particular category into user-defined spending accounts or envelopes. This allocation enables the user to see in real time the impact of current spending according to the established budgetary guidelines. Once the user sees that the funds are nearly exhausted for a given spending account, the user can reign in his/her spending consistent with the established budget based on available funds for the envelope.

Each user-defined spending account or envelope is selectively associated with one or more transactional accounts. This allows the user to employ transactional accounts for making purchases, and provides the user with such benefits as receiving rewards (e.g., frequent flyer miles, cash back bonuses, and other such perks) from use of the transactional accounts, maintaining actual funds in interest-baring source accounts for longer periods of time, using transactional accounts to perform transactional adjustments rather than tying up actual funds in a source account, and other similar benefits.

In accordance with embodiments of the present invention, a user is enabled to manage his/her own accounts. Features available to a user to assist in managing the accounts include automated expense categorization, tracking, and trimming, automatic bank and credit card account tracking and reconciliation in conjunction with the accounts managed, automatic on-line bill pay from the various expense categorizations, on-line bill presentment where desired, e-mail payment ability, point-of-sales tools, personal credit card processing tools, and automatic report generation.

During an initial account set-up, a user determines what type of tracking set-up is to be established. The user may select either an auto track set-up or a full track set-up. The auto track set-up performs activities in an automated fashion on behalf of the user. The full track set-up allows the user to set up on-line bill payment as well as the ability to manipulate any default category available in the auto set-up mode. The full track set-up also allows the user to manipulate the default category settings that are typically found in the auto track set-up and allows the user to start tracking account expenses to some date prior to the date of set-up. In the auto track set-up mode, default category settings are established that are based upon balances received during an on-line or set-up entry interview with the user to establish starting balances. In the auto track mode, the account tracking activity begins as the day of set-up. The system proceeds to interview the user to provide information such as name, address, type of program or accounts to be utilized, home address, home phone number, fax numbers, and email address. Further, an on-line provider information is secured so that the user may use on-line communication tools to access on-line content providers as shown in FIG. 2.

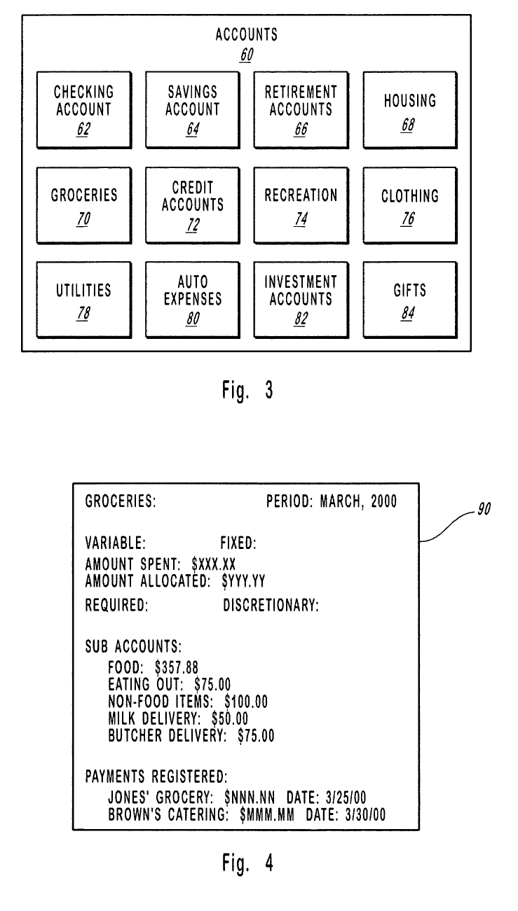

Next, the user establishes the types of accounts that are to be tracked. By way of example, typical types of accounts are illustrated in the block diagram of FIG. 3. These accounts include a personal checking account 62, a personal savings account 64, various retirement accounts grouped together in retirement accounts 66, housing account 68, groceries account 70, credit accounts 72, recreation account 74, clothing account 76, utilities account 78, auto expense account 80, investment accounts 82, and gift accounts 84, and any other accounts of the user. Checking account 62, savings account 64, retirement accounts 66, investment accounts 82 are examples of source accounts. Credit accounts 72 are examples of transactional accounts. Housing 68, groceries 70, recreation 74, clothing 76, utilities 78 auto expenses 80 and gifts 84 are examples of spending accounts. Examples of additional accounts may include personal brokerage investment and personal insurance accounts.

The user defines the various accounts with more or less accounts actually being established. The accounts illustrated are not limiting with respect to the implementation of the invention, but are merely illustrative of types of accounts that may be employed. Further, the accounts may be actual accounts, such as savings and checking accounts, or virtual accounts, such as clothing and auto expense accounts. Both types of accounts may be utilized at the same time, with the virtual accounts being automatically reconciled with the actual accounts.

When establishing an account, such as, for example, a personal checking or savings account, the user is interviewed to, for example, select the institution in which the account is held, provide an account friendly name, such as my checking account or our joint checking account, including a starting balance, a start date, and any on-line user name and password information that facilitates the on-line communication between the financial institution and the user. Similar procedures are utilized for establishing other accounts, such as personal credit card accounts, retirement accounts, brokerage investment accounts, and insurance accounts. For each account relevant information is provided during the interview, such as an account number or provider, starting balances, start dates, user names and passwords.

Once the interview has been completed, the user may selectively return to modify any of the accounts, or add/delete any accounts as desired. Accordingly, dynamic and flexible systems and methods are provided that allow users to make modifications so that changes can be readily made and integrated according to the user's desires.

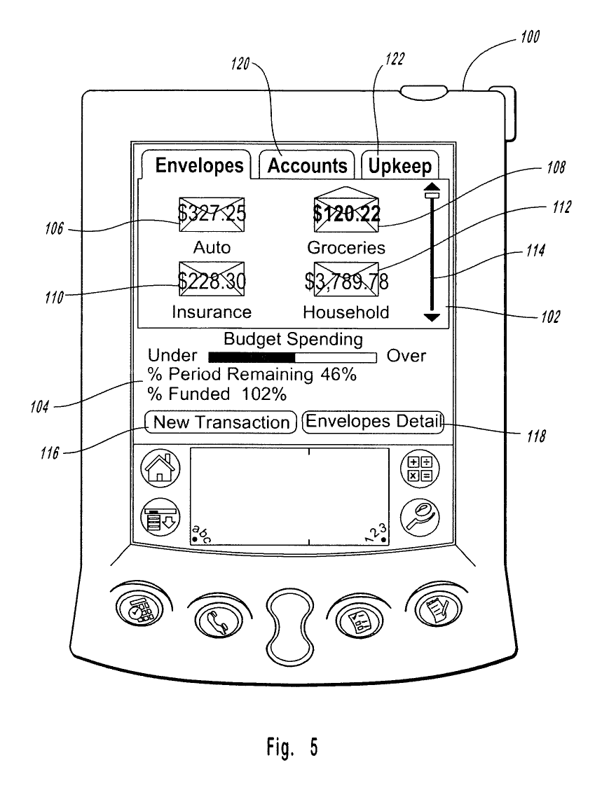

With reference now to FIG. 4, a user may establish various spending/expense accounts, such as expense account 90, which is labeled as “GROCERIES.” The expense accounts/envelopes are established to provide budgeting means for following a personal budget. Expense account 90 is established with a current available account balance as well as with expected inflows. The user may define whether the envelope is to cover fixed required expenses at fixed intervals, such as through on-line bill payments, or whether it is variable required expenses at fixed intervals, variable required expenses at variable intervals, such as credit/debit or other on-line bill pays, or variable discretionary expenses at variable intervals for expenses that cannot be routinely predicted.

For each account as shown in FIG. 3, the user goes through and defines the envelopes within those accounts. For example, multiple checking accounts may be utilized within one envelope or many envelopes for each account. Likewise, for the savings accounts, the user may establish how many envelopes are desired for the number of accounts.

The account envelopes, such as the one shown in FIG. 4, allow the user to manage discretionary spending in a more detailed and concise way. For example, in FIG. 4, the GROCERIES account has been selected and a budgeting period (March 2000) has been established. The period is any period (e.g., daily, weekly, monthly, quarterly, yearly or any other period) defined by the user. When setting up an account, the user defines whether the account is a variable expense or a fixed expense account. Since groceries typically vary in a nominal way, it can be selected as a fixed account, such as when the user has a buying relationship with a particular grocer who follows a purchase list and delivers the groceries to the user for a fixed rate. Otherwise, the user typically goes to the grocery store and makes the desired purchases and then enters the information in the account system at a later time.

The user may or may not know the expenses on a monthly basis that are incurred in securing food and other grocery items. As such, the user may select this as a fixed account or a variable account. The user then provides an amount allocation, which is the ceiling to which the user is able to draw/spend from this particular account. The account shows the ongoing cash balance in the account. The account also shows how much is actually spent in the amount spent field.

Groceries may also be defined as hybrid accounts such that they are required, but are often allowed discretionary purchases. As such, this would be a hybrid that the user would select. Selective sub-accounts are shown in the sub-accounts field and these can include such fields as food, eating out, non-food items, milk delivery, butcher delivery, and any other discretionary sub-account desired by the user to reflect the user's life style and purchasing spending habits. In this example, it is shown that each of the sub-accounts has incurred a certain expense for the month. This allows the user to see where the spending habits are so that appropriate lifestyle changes may be made if the spending is above budget. Further, the account allows the user to provide on-line payment and is represented by the payments registered field shown in FIG. 4.

In the illustrated example, the user has a payment to Jones Grocery on March 25, and a second one to Brown's Catering on March 30. These payments may have been made using one or more transactional accounts. In accordance with embodiments of the present invention, when a transactional account is used to make a payment, corresponding funds from a source account are set aside or placed in a separate account until the transactional account statement is received. This allows for the transactional account statement to be paid in full at the end of each billing period, as will be further discussed below.

With reference back to FIG. 3, each account 60 includes similar fields, such as an amount allocated field as well as an amount spent field. This allows the user to be constantly informed as to the amount that has been spent from a particular account/envelope and the amount that is available to be spend from the account. This also ensures that the user conforms to the budget established, thereby providing real-time financial discipline upon the user.

Each account, as well as each and all sub-accounts within a given account, may be modified according to the user's discretion. For example, if the user finds that he or she has greater financial resources than previously entered, then discretionary increases may be made in each allotted amount. On the other hand, if the user suffers a financial setback, then the user can manage the budget and the amount allocated for a particular field to better control the financial resources.

There are certain accounts that are typically fixed, such rent/mortgage accounts, and auto loan payments. Typically these accounts are set up to be paid in an automated fashion with resources being allocated directly from the paycheck or other sources of income that the user has in order to fund these accounts. In another embodiment, a transactional account may be used in accordance with the present invention to make these automatic payments and funds are set aside from a source account for full payment of the transactional account statement upon receipt. This allows the user to obtain benefits from using the transactional account, as discussed herein.

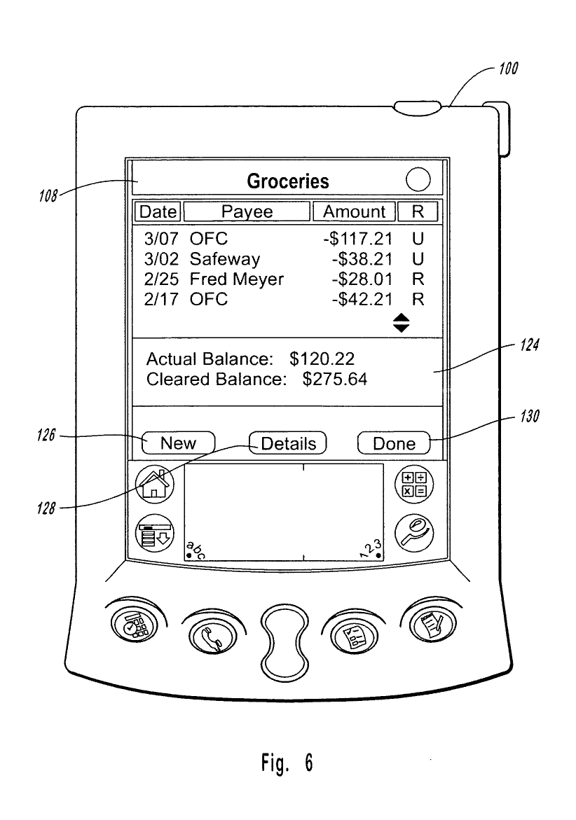

With reference now to the embodiment illustrated in FIG. 5, the envelopes are shown in use on a computer device, illustrated as personal digital assistant (PDA) device 100, which includes a viewing window 102 to display information for the user. Viewing window 102 also is a touch screen panel that allows the user to directly access a particular envelope with a stylus. Additional information is provided in graphical form to convey budget information. For example, a budget spending bar 104 is shown to illustrate what percentage of the budget has been spent. Each envelope (e.g., an auto envelope 106, groceries envelope 108, insurance envelope 110, and household envelope 112) shows the available balance remaining corresponding to the icon representation of the same. Additional envelopes are shown upon scrolling up or down the window via scroll bar 114. When the user selects an icon, envelope summary information (shown in FIGS. 4 and 6) is displayed. The user may also select to enter a new transaction via transaction icon 116 of FIG. 5 or select envelope detail via icon 118.

While the illustrated embodiment provides the accessibility of expense accounts/available, the interface also provides the user with access other accounts (e.g., transactional and source accounts) via accounts folder 120. Moreover, management options are available through upkeep folder 122.

With reference now to FIG. 6, an illustration is provided of device 100 with a detail screen 124 for a selected expense account/envelope. In this example, the groceries envelope 108 has been selected and the information displayed includes specific transactions as well as an actual balance total and a cleared balance total. The specific transactions include the date entered, the payee's name, the amount of the transaction, etc. The user may select new icon 126 to enter a new transaction, select details icon 128 to view or edit more details of a given transaction, or select done icon 130 to close the envelope and return to the display illustrated in FIG. 5.

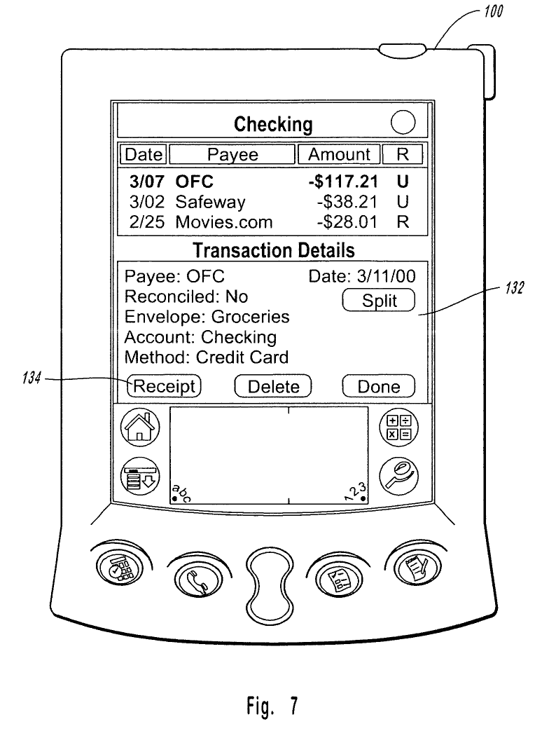

With reference now to FIG. 7, an illustration of device 100 is provided with detail screen 132, which provides the details for a particular transaction that has selected from the display of FIG. 6. In FIG. 7, the information includes the payee's name, the date of the transaction, whether the transaction has been reconciled with a corresponding account, what money envelope it belongs to, from which account the payment is actually made, and the method of payment (e.g., debit card, credit card, check, money order, cash, etc.). These details can provide an electronic receipt by selecting icon 134.

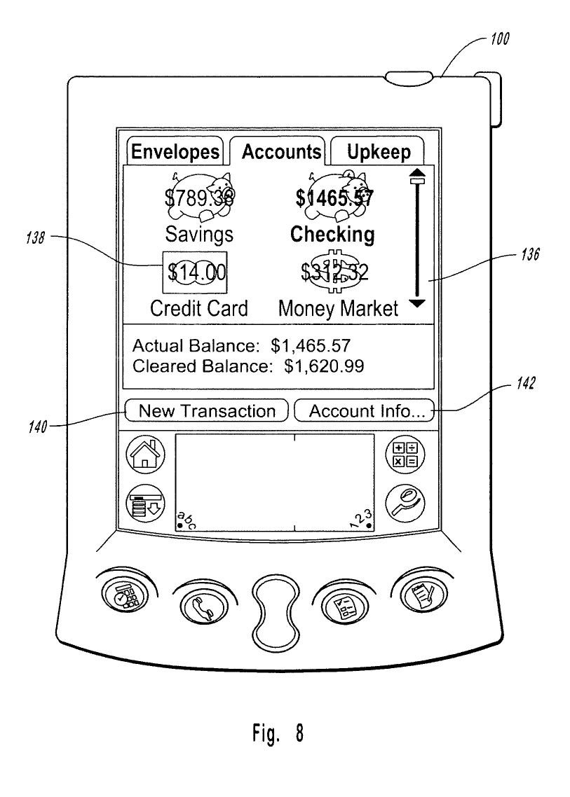

In the illustrated example, if the user selects the accounts folder 120 (FIG. 5), screen 136 (FIG. 8) is displayed. Screen 136 provides information regarding each source and transactional account the user has established in the form of an account icon that includes the current remaining balance within each account. When the user selects an account, the actual and cleared balances are displayed below the account icon field 138. The user can enter new transactions or account information for a desired account via transaction icon 140 or account information icon 142.

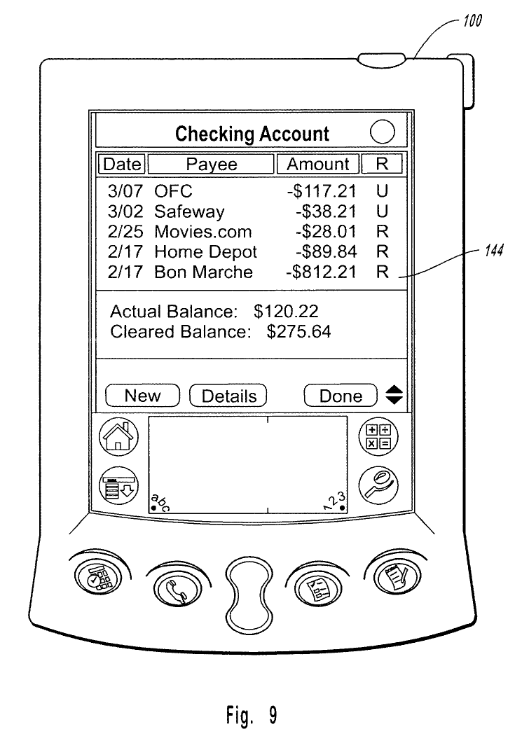

With reference now to FIG. 9, an illustration is provided of device 100 with screen 144 that displays account detail information for a selected account. For this example, the checking account has been selected and various transactions are displayed and can be selected for additional details. The date, payee's name, amount, and reconciliation information are provided for benefit of the user.

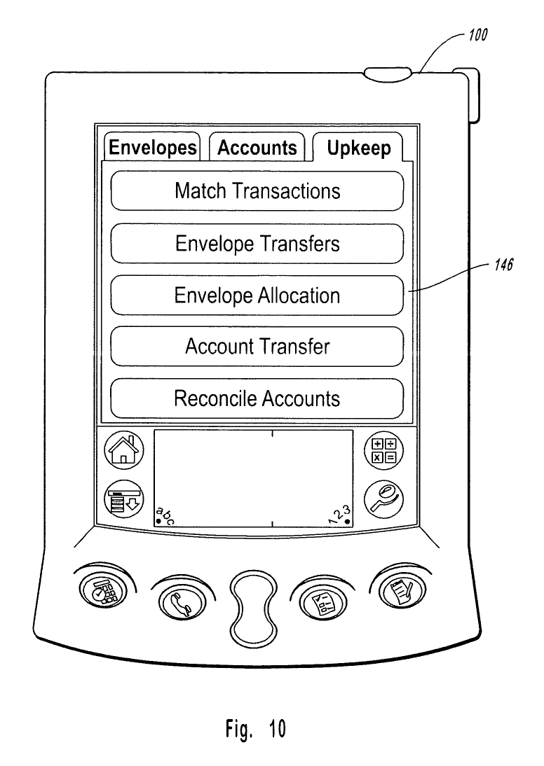

With reference now to FIG. 10, an illustration is provided of device 100 with screen 146, which provides representative options available under upkeep folder 122 (FIG. 5). Within the upkeep folder are the options of accepting, allocating, and matching incoming transactions, performing transfers of excess cash from one expense account/envelope to one or more other envelopes as desired. Further, the upkeep options allow the user to transfer cash from one account to another and to perform account reconciliation.

Other options include report generation, wherein the reports are be based upon the user's request to see transactions by envelopes or payee, to see a cash flow statement, and/or to provide reconciliation reports between the account statement from the financial institution and the user's personal register. Further, a budgetary report can be generated that shows the spending status for each of the accounts. Additionally, a retirement calculator allows the user to project a future value of amounts given on a certain interest rate. The reports may include different expense accounts for any particular account or for the entire system as a whole.

Thus, embodiments of the present invention embrace managing spending through account allocation, which provides accountability among various groups of accounts, including source accounts and transactional accounts. The following provides a discussion relating to account allocation to allow a user to use transactional accounts and receive the benefits of such accounts, and to provide fiscal responsibility by ensuring that funds are available when a transactional account statement requires payment.

### Allocating Funds for a Transactional Account Statement

As provided above, embodiments of the present invention take place in association with a computer device that is used to provide financial resource allocation and accountability among various groups of accounts, including source accounts and transactional accounts. Source accounts include funds or assets that are readily available to the user. Examples of source accounts include savings accounts, checking accounts, money market accounts, investment accounts, etc. Transactional accounts are based on credit or equity and may be used to purchase a product or service, but requires that the amount accrued on the transactional account be paid at a later time. Examples of transactional accounts include credit card accounts, home equity accounts, etc.

In accordance with an embodiment of the present invention, when a user employs a transactional account to make a purchase, the amount of the purchase is electronically set aside from a source account or deposited into a holding account and preserved until a payment is required of the transactional account at the close of a billing period. Thus, for example, when a user selects a credit card to use to purchase a product, the corresponding credit card company authorizes the purchase, includes the purchase amount on the user's credit card account, and eventually bills the user for all amounts on the credit card account at the end of a billing period. At the time the credit card is used to perform the purchase, the purchase amount is set aside, frozen or deposited into a holding account from a selected source account (e.g., a checking account) that has sufficient funds therein until the credit card statement is received. Thus, when a payment is required for the credit card account, the purchase amount that was set aside from the savings account is used to pay the credit card statement.

Accordingly, a source account is essentially debited each time a transactional account is used to perform a transaction and the amount debited is preserved until payment of the transactional account is required. Thus, when the transactional account requires a payment, funds are available to make a full payment of all purchases made during the billing cycle, thereby affording financial discipline to the user.

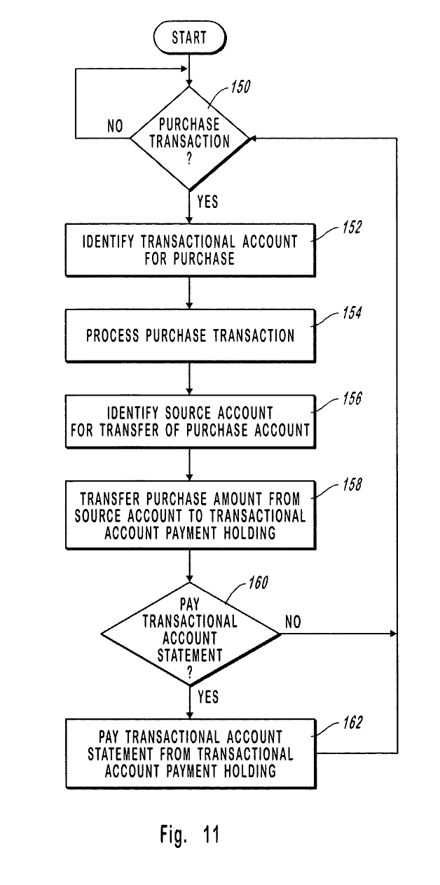

With reference now to FIG. 11, a representative method for allocating funds for transactional account statements is provided. In FIG. 11 execution begins at decision block 154 for a determination as to whether or not a purchase transaction is to occur that would require the use of a transactional account. Accordingly, if it is determined decision block 150 that a purchase transaction is not to occur at this time, execution returns back to start. Alternatively, if it is determined at decision block 150 that a purchase transaction is to occur, execution proceeds to step 152.

At step 152 the transactional account that is to be used for the purchase is identified. In one embodiment, the identification occurs by a user selecting a particular credit card for use in making a purchase. In another embodiment, the identification is performed previously in order to provide an automatic withdrawal from the transactional account. Execution then proceeds to step 154, where the purchase transaction is processed. For example, a transaction is processed by a credit card company identifying that the transactional amount is available in credit, authorizing the transaction, and deducting the purchase amount from the user's credit limit.

Execution then proceeds to step 156 for the identification of a source account from which the purchase amount may be set aside, frozen or transferred to a holding account/envelope. In one embodiment, the user is prompted as to which source account the user desires to use in order to set aside, freeze or transfer the available funds to eventually pay for the amount of the purchase.

Execution then proceeds to step 158 where the purchase amount is, for example, transferred from the identified source account to a transactional account payment holding. In one embodiment, the transactional account payment holding is an electronic flag indicating that the funds have already been spent and/or that the funds will be used to pay a particular transactional account statement. In another embodiment the transactional account payment holding is an actual account/envelope to which funds are transferred.

Execution then proceeds to decision block 160 for determination as to whether or not to pay a transactional account statement. A transactional account statement requires payment on a periodic basis. Thus, if it is determined at decision block 160 that a transactional account statement has not been billed and thus that it is not time to pay the transactional account statement, execution returns back to decision block 150 for a determination as to whether or not another purchase transaction will occur. As provided above, if it is determined at decision block 150 that another purchase transaction is not to occur, execution returns back to start. Alternatively, if it is determined at decision block 150 that another purchase transaction is to occur, execution proceeds through steps 152-158 to identify the transactional account that will be used for the purchase, process the purchase transaction, identify the source account from which the funds of the purchase amount will be set aside, frozen or transferred, and allocate the purchase amount from the source account for use in making a future payment on the transactional account.

Once it is determined at decision block 160 that it is time to pay the amount owing on the transactional account statement, execution proceeds to step 162, where the transactional account statement is paid from, for example, the transactional account payment holding. Embodiments of the present invention embrace the full payment of the transactional account statement to prevent unnecessary assumption of debt and to provide fiscal responsibility. Execution then proceeds to decision block 150 for determination as to whether or not to perform another purchase transaction. As provided above, if another purchase transaction is to occur, execution proceeds through steps 152-158. Alternatively, if it is determined a decision block 150 that purchase transaction is to occur at this time, execution returns back to start.

The flow chart of FIG. 11 illustrates both a representative purchase and a representative payment in accordance with an embodiment of the present invention. In another embodiment, a purchase includes identifying the transactional account for use to make a purchase, processing the purchase by utilizing the financial institution corresponding to the transactional account using a server to capture the transaction from a financial institution, allowing the user to download the transaction from the server to the user's computer device, assigning the transaction to a particular account, subtracting the transaction amount from the account and either adding the transaction amount to an account that is used to pay the transactional account statement in order to set aside the funds during the process, or adding the transaction amount to the transactional account.

Another embodiment for providing a payment of a transactional account statement includes allowing the user to view the amount owing on a transactional account statement and paying that amount from the source account, allowing the payment from the source account to be processed by a financial institution, using the server or other computer device to capture the payment from a financial institution, allowing the user to download the payment information from the server to a computer device, assigning the payment to a particular account, subtracting the amount of the payment from the account, posting the payment against the transactional account, and subtracting the payment from the source account.

Thus, as discussed herein, embodiments of the present invention embrace systems and methods for providing electronic management of transactional accounts. In particular, the present invention relates to systems and methods for allocating funds for payment of one or more transactional account statements. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

1. In a system that includes a computer device, a method for allocating funds for payment of a transactional account statement, the method comprising the steps for:
using a transactional account to make a first purchase;
electronically reserving a first amount of funds available from a first source account for use in making a transactional account payment, wherein the first amount allocated corresponds to the first purchase;
receiving a request to pay the transactional account payment; and
using the first amount allocated to pay the transactional account payment.

2. The method as recited in claim 1, further comprising the steps for:
using the transactional account to make a second purchase;
electronically reserving a second amount of funds available from a second source account for use in making the transactional account payment, wherein the second amount allocated corresponds to the second purchase; and
using the first and second amounts allocated to pay the transactional account payment.

3. The method as recited in claim 2, wherein the second source account is the first source account.

4. The method as recited in claim 1, wherein the transactional account is one of:
(i) a credit account; and
(ii) an equity account.

5. The method as recited in claim 1, wherein the first source account is one of:
(i) a savings account;
(ii) a checking account; and
(iii) an investment account.

6. The method as recited in claim 1, wherein the step for using a transactional account to make a first purchase comprises the step for using the computer device to provide transactional information corresponding to the transactional account to a vendor to make the first purchase.

7. The method as recited in claim 1, wherein the step for using a transactional account to make a first purchase comprises entering an amount of the first purchase into the computer device to track purchases make by the transactional account.

8. The method as recited in claim 1, wherein the step for electronically reserving a first amount of funds comprises the steps for:
identifying the first source account; and
determining whether the first source account includes sufficient available funds to cover the first amount of funds.

9. The method as recited in claim 1, wherein the step for electronically reserving a first amount of funds comprises at least one of the steps for:
designating the first amount of funds for use in making the transactional account payment; and
placing a the first amount of funds into a holding account until payment of the transactional account is made.

10. The method as recited in claim 1, wherein the request is an electronic request received by the computer device.

11. The method as recited in claim 1, wherein the request is an entry made by a user after receipt of the transactional account statement.

12. The method as recited in claim 1, wherein the step for using the first amount allocated to pay the transactional account payment includes the step for making an electronic transfer of funds from the first source account to the transaction account.

13. The method as recited in claim 1, wherein the step for electronically reserving a first amount of funds further comprises the steps for:
using a server to capture the purchase from a financial institution;
downloading the purchase from the server to the computer device; and
assigning purchase to the first source account.

14. A system for selectively allocating funds for payment of a transactional account statement, the system comprising:
a transactional account configured for use in making purchases;
a source account that includes available funds; and
a computer device that is configured to reserve a purchase price from available funds of the source account each time the transactional account is used to make a purchase, and wherein the computer device is configured to use the sum total of the reservations made on the available funds during a billing period for payment of the transactional account for the billing period.

15. The system as recited in claim 14, wherein the transactional account is base on one of:
(i) credit; and
(ii) equity.

16. A computer program product for implementing within a computer system a method for allocating funds for payment of a transactional account, the computer program product comprising:
a computer readable medium for providing computer program code means utilized to implement the method, wherein the computer program code means is comprised of executable code for implementing the step for:
electronically reserving a first amount of funds available from a first source account for use in making a transactional account payment, wherein the first amount allocated corresponds to a purchase made using a transactional account.

17. The computer program product as recited in claim 16, further comprising executable code for implementing the steps for:
providing first transactional information corresponding to the transactional account to make a first purchase;
receiving a request to pay the transactional account payment; and
using the first amount allocated to pay the transactional account payment.

18. The computer program product as recited in claim 17, further comprising executable code for implementing the steps for:
providing second transactional information corresponding to the transactional account to make a second purchase;
electronically reserving a second amount of funds available from a second source account for use in making the transactional account payment, wherein the second amount allocated corresponds to the second purchase; and
using the first and second amounts allocated to pay the transactional account payment.

19. The computer program product as recited in claim 16, wherein the step for electronically reserving a first amount of funds comprises the steps for:
identifying a source account; and
determining whether the source account includes sufficient available funds to cover the first amount of funds.

20. The computer program product as recited in claim 16, wherein the step for electronically reserving a first amount of funds comprises at least one of the steps for:
designating the first amount of funds for use in making a transactional account payment; and
placing a the first amount of funds into a holding account until payment of the transactional account is made.
